(19) United States
(12) Patent Application Publication
(10) Pub. No.: US 2009/0026051 A1
(43) Pub. Date: Jan. 29, 2009

(54) Input device for rapid triggering of rolling signals

(75) Inventors: Chin-Wen Chou, Taipei Hsien (TW); Tsui-Jung Su, Taipei Hsien (TW)

Correspondence Address: Joe McKinney Muncy, PO Box 1364, Fairfax, VA, 22038-1364, US

(73) Assignee: ZIPPY TECHNOLOGY CORP.

(21) Appl. No.: 11/878,230

(22) Filed: Jul. 23, 2007

(51) Int. Cl. H01H 19/56

(52) U.S. Cl. 200/11 R

(57) ABSTRACT

The present invention includes a wheel mounted onto an electronic device through a holding rack and turnable freely under an external force. The wheel has a click portion to generate signals that consists of concave and convex portions formed radially and equally spaced from one another. A signal generation means is provided including at least two legs and a conductive element located between the two legs having an elastic return force. The conductive element is moved to connect the two legs due to rotation of the click portion to generate instruction signals. A friction force is generated when the conductive element is connected to the click portion. A rotation resistant force is generated when the conductive element and the rotating click portion are connected. A composite force is formed by the force to generate rotation and the rotation resistant force. The composite force forms an inverse relationship with the weight of the wheel.

### FIELD OF THE INVENTION

The present invention relates to a computer input device and particularly to a computer input device to rapidly trigger rolling signals to facilitate fast scrolling of images displayed on a screen.

### BACKGROUND OF THE INVENTION

Conventional computer input devices have a wheel which can be rotated to allow images on a screen to be scrolled rapidly about an axis. R.O.C. patent No. M261764 discloses an index input device to provide page flipping function. It is adopted on a portable computer equipped with a display device. It includes a rolling strip formed in an elongate manner with a bulged strip formed respectively in the axial direction on each of opposing sides. The rolling strip further has at least one optical grid, a control circuit board held in the chassis of the portable computer. The control circuit board has a photoelectric emission means and a photoelectric receiving means and an opening. It is installed on the chassis mating the shape of the rolling strip. The opening has two ends mating the bulged strip. The chassis has an aperture on an extension portion to hold the two bulged strips. By coupling the aperture and the two bulged strips the rolling strip can be held in the opening in a hinged manner. The rolling strip can be rotated relative to the opening. The photoelectric receiving means can detect whether optical signals emitted from the photoelectric emission means are masked by the optical grid during rotation of the rolling strip. Thereby page flipping function of a display picture on the display device of the portable computer can be controlled.

The index input device mentioned above controls scrolling of a single page image of the picture in an equal-spaced fashion through the optical grid and alteration of the optical signals. These days data content is huge. One copy of an ordinary document usually contains dozen or hundred pages. The wheel elements adopted for scrolling single page image can not meet the requirement that has to scroll dozen or hundred pages of images. To address this issue, computer input devices for rapid scrolling of images have been developed. For instance, Logitech Co. has produced a mouse VX revolution (http://www.logitech.com/index.cfm/mice_pointers/mice/devices/165&cl=us,en) and MX Revolution (http://www.logitech.com/index.cfm/mice_pointers/mice/devices/130&cl=us en). Through a precise MicroGear image scrolling speed increases significantly. It has a ratchet gear roller means outside the MicroGear to clamp the axle of the MicroGear in regular conditions. The rotation speed of the MicroGear is slowed down to allow users to sense clicks generated by coupling of the axle of the MicroGear and spaced concave and convex portions of the ratchet gear roller means. Thereby image scrolling speed on the display device also slows down. When the ratchet gear roller means is released from the axle of the MicroGear, the MicroGear can rotate rapidly to enable the users to feel a smooth touch on rotation of the axle. The images shown on the display device can also be scrolled quickly.

However, the precise MicroGear previously discussed has to add an extra ratchet gear roller means. This causes severe space constraint on the limited space in the input device. Fabrication cost and time of the input device also increase. How to resolve the aforesaid problems occurred to the computer input devices is an issue remained to be overcome in the industry.

### SUMMARY OF THE INVENTION

The primary object of the present invention is to provide an input device to facilitate rapid scrolling of images displayed on a computer screen without adding extra elements.

To achieve the foregoing object the invention provides an input device that can rapidly trigger rolling signals. It includes a wheel mounted onto an electronic device through a holding racked and turnable freely under an external force. The wheel includes a click portion consisting of concave and convex portions that are formed radially and equally spaced from one another to generate signals at a selected interval, and a signal generation means which has at least two legs and a conductive element located between the two legs that has an elastic return force. The conductive element is triggered by rotation of the click portion and moved to connect the two legs to generate instruction signals. A friction force is generated while the conductive element is in contact with the click portion. When the conductive element is in contact with the click portion, a friction force is generated. A rotation resistant force also is generated while the conductive element is in contact with the rotating click portion. The composite force of the rotation force and rotation resistant force forms an inverse relationship with the weight of the wheel, thereby the frequency of instruction signal generation of the signal generation means can be determined.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of an embodiment of the invention.

FIG. 2 is an exploded view of an embodiment of the invention.

FIG. 3 is a schematic view of an embodiment of the invention in an initial still condition.

FIG. 4 is a schematic view of an embodiment of the invention in a rotating condition with the wheel subject to a smaller force.

FIG. 5 is a schematic view of an embodiment of the invention in a rotating condition with the wheel subject to a greater force.

FIG. 6 is a schematic view of an embodiment of the invention showing sway displacements of the conductive element.

FIG. 7 is a schematic view of an embodiment of the invention with images scrolling at a slow speed.

FIG. 8 is a schematic view of an embodiment of the invention with images scrolling at a fast speed.

### DETAILED DESCRIPTION OF THE PREFERRED EMBODIMENT

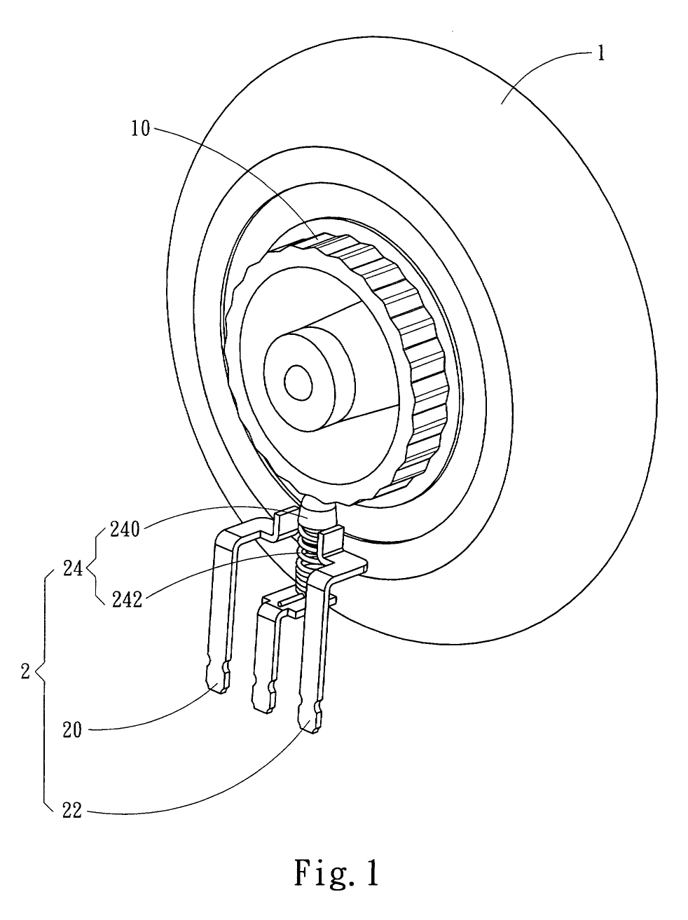

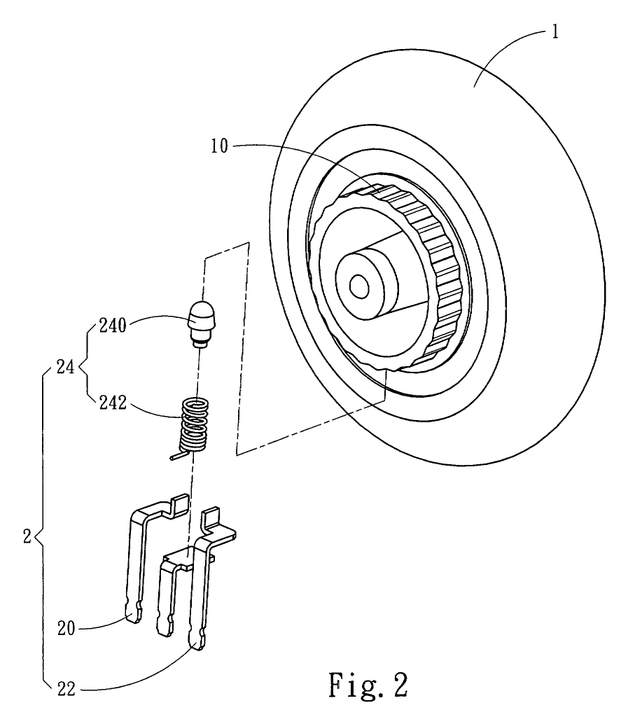

Refer to FIGS. 1 and 2 for an embodiment of the invention. It is an input device to rapidly trigger rolling signals. It includes:

a wheel 1 which is mounted onto an electronic device through a holding rack and can rotate freely when subject to an external force. It has a click portion 10 consisting concave and convex portions that are formed radially and equally spaced from one another to generate signals at a selected interval. The wheel 1 has a rotational inertia determined by the weight and an axle of the wheel 1. In this embodiment the wheel 1 is a disk and has a rotational inertia about one half of the multiplication product of the weight and the square of the axle of the wheel 1; and

a signal generation means 2 which includes at least two legs 20 and 22 and a conductive element 24 located between the two legs 20 and 22 that has an elastic return force. The conductive element 24 is in contact with the rotating click portion 10 and moved to connect either of the two legs 20 and 22 to generate instruction signals. Moreover, when the conductive element 24 is in contact with the click portion 10, a friction force is generated. In this embodiment the conductive element 24 includes a metal pin 240 and an elastic element 242 connecting to one end of the metal pin 240. The elastic element 242 has one end connecting to a first electrode (not shown in the drawings). The two legs 20 and 22 are connected respectively to a second electrode and a third electrode (also not shown in the drawings). As the conductive element 24 can be in contact with the rotating click portion 10 and driven to connect the two legs 20 and 22, the first, second and third electrodes can be connected to generate instruction signals. The metal pin 240 has a top end in contact with the click portion 10 in regular conditions.

When the conductive element 24 is in contact with the rotating click portion 10, a rotation resistant force is generated thereon. The force which generates rotation and the rotation resistant force form a composite force. The composite force forms an inverse relationship with weight of the wheel 1 to determine the frequency of instruction signal generation. The inverse relationship is formed by the composite force against the rotational inertia. In this embodiment the rotation resistant force includes the friction force occurred between the conductive element 24 and the click portion 10 and the elastic return force of the conductive element 24. Based on the rotational inertia of the disk-like wheel 1, the inverse relationship is formed by a net value derived by subtracting two times of the multiplication product of the rotation resistant force and the rotation moment of force from the multiplication product of the rotation force and the rotation moment of force divided by the weight and the square of the axle of the wheel 1.

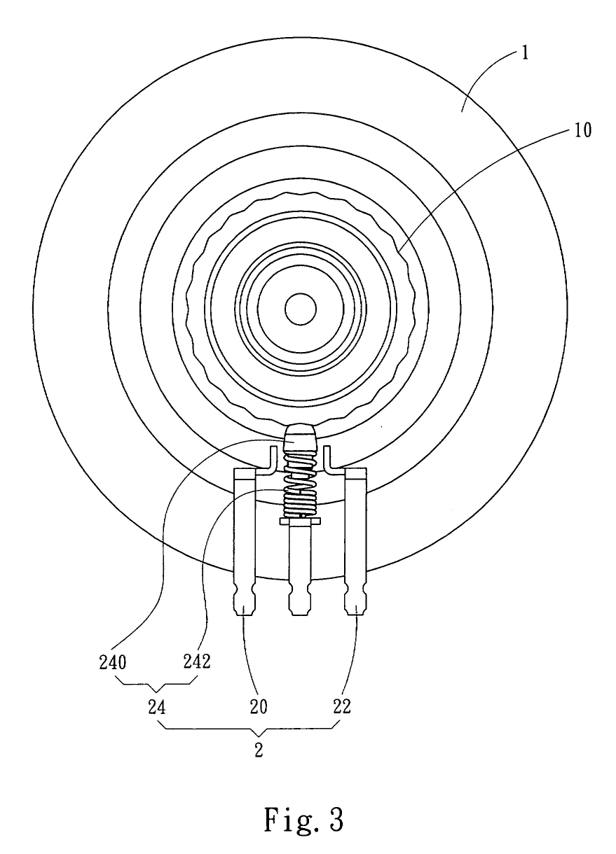

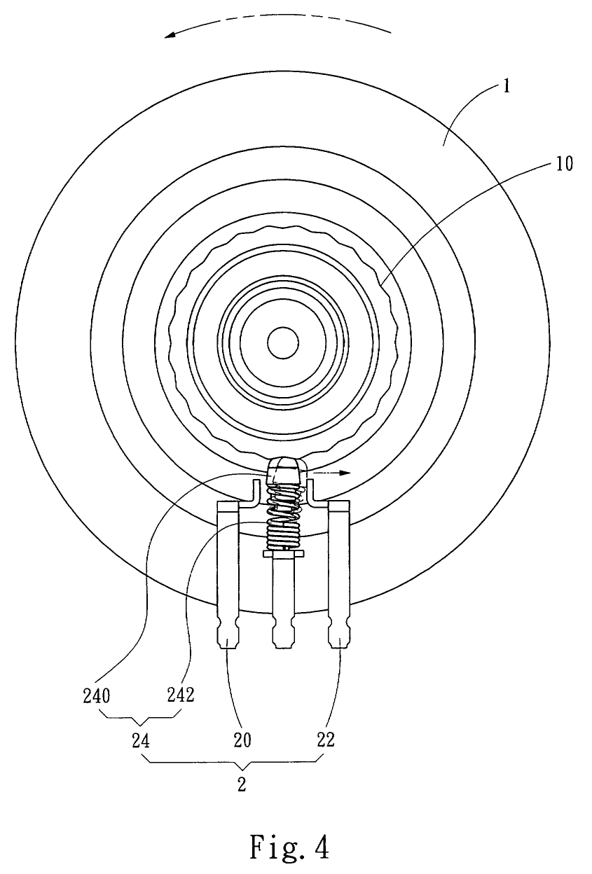

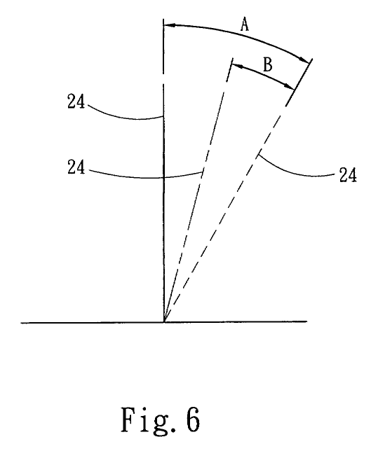

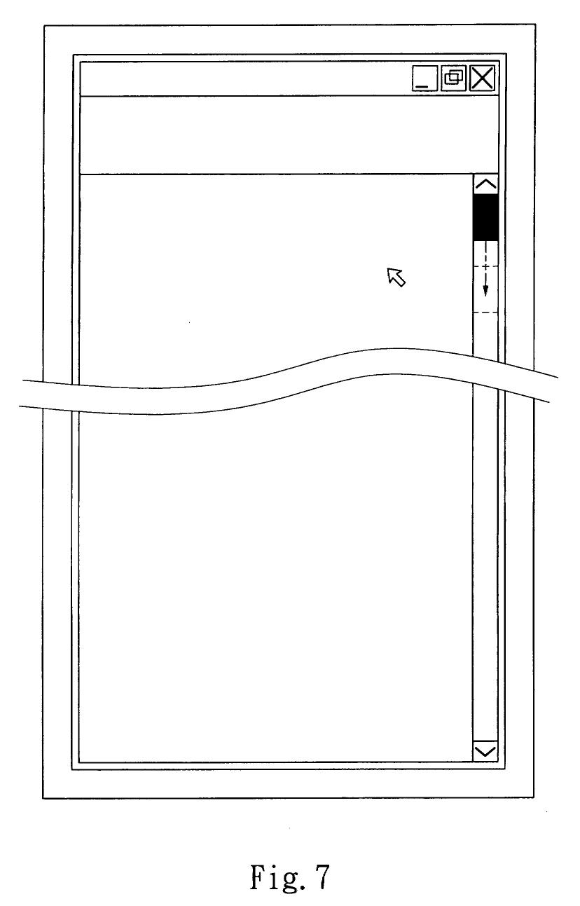

When in use, the conductive element 24 and the wheel 1 are initially in a still condition (referring to FIG. 3). When a small force is applied to the wheel 1, the elastic return force of the conductive element 24 can make the top end of the conductive element 24 to bounce back immediately to the original still condition (referring to FIG. 4) to form a first sway displacement A (also referring to FIG. 6). Through the composite force resulting the elastic return force of the conductive element 24 and the friction force between the conductive element 24 and the wheel 1, rotation of the wheel 1 is resisted. Hence users can feel a rotation click sense intermittently while the wheel 1 rotates. Meanwhile, the intermittent displacement generated by the conductive element 24 forms connection to the leg 22. As a result, the instruction signals are generated intermittently. While the wheel 1 rotates intermittently images can be scrolled slowly and axially (referring to FIG. 7).

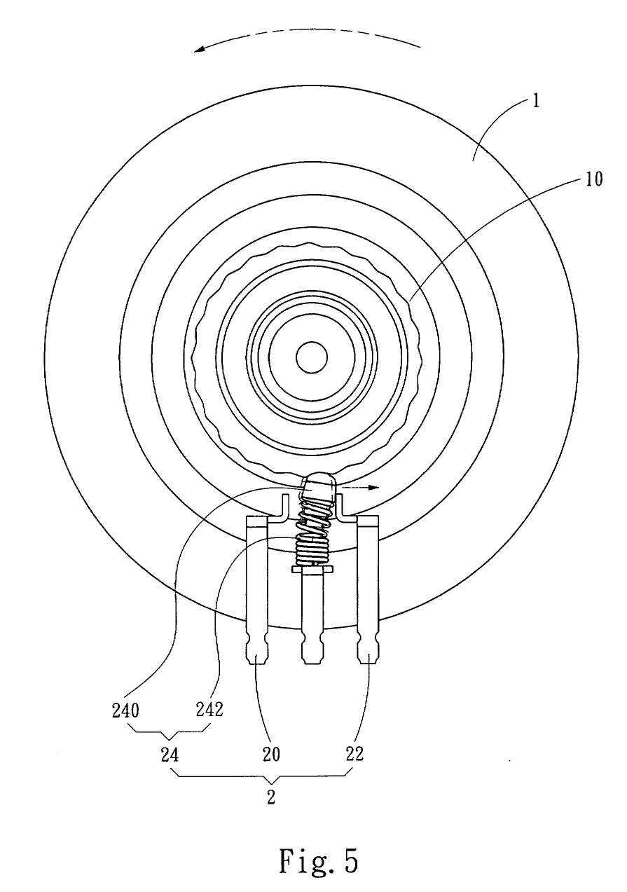

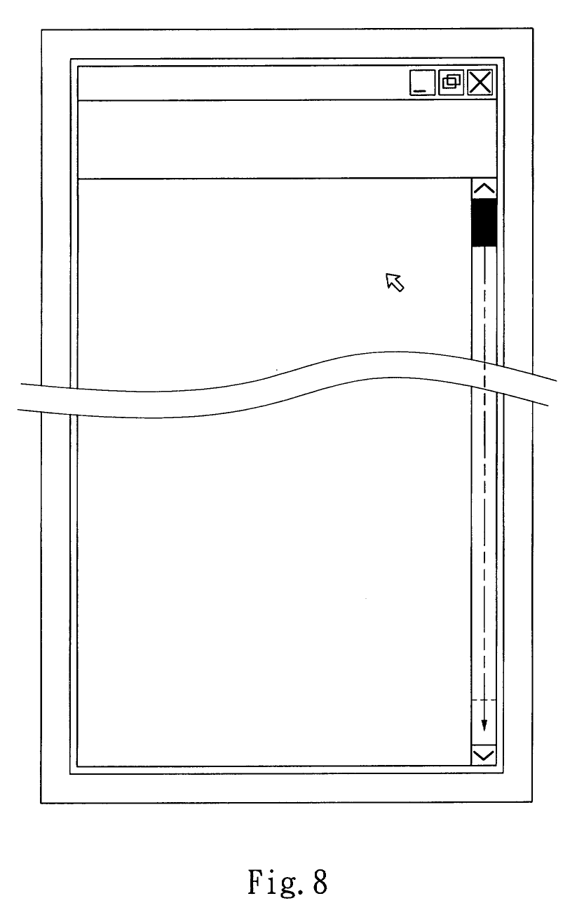

When the wheel 1 receives a greater force, the elastic return force of the conductive element 24 is not adequate to return immediately the top end of the conductive element 24 in the initial still condition (referring to FIG. 5). The top end of the conductive element 24 is swayed and tilted to the second leg 22 without returning to the initial still condition, and forms a second sway displacement B (referring to FIG. 6). Compared with the first sway displacement A, the second sway displacement B is shorter and has a smaller rotation resistant force. Hence the wheel 1 can rotate smoothly to give the users a smoother sense of rotational click. In addition, the smaller second sway displacement B allows the conductive element 24 to be moved faster to connect the leg 22. As a result, a greater amount of instruction signals can be generated within a unit time period than that in the first sway displacement A. Hence the images can be scrolled quickly and axially while the wheel 1 rotates (also referring to FIG. 8).

In short, the invention generates instruction signals by connecting the connective element 24 to the two legs 20 and 22. There is not need to squeeze a ratchet gear roller means in the limited space of the computer input device. Fabrication cost and time can be reduced. Market competitiveness of the resulting product can be enhanced. The images can be scrolled quickly without additional elements. It provides a significant improvement over the conventional techniques.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An input device for rapid triggering of rolling signals, comprising:
a wheel which is mounted onto an electronic device through a holding rack and turnable freely when subject to an external force and has a click portion consisting of concave and convex portions that are formed radially on the wheel and equally spaced from one another to generate signals at a selected interval; and
a signal generation means which includes at least two legs and an conductive element located between the two legs that has an elastic return force, the conductive element being movable through rotation of the click portion to connect the two legs to generate instruction signals, the conductive element being connectable to the click portion to generate a friction force;
wherein a rotation resistant force is generated while the conductive element is connected to the rotating click portion, the force to generate rotation and the rotation resistant force forming a composite force which forms an inverse relationship with the weight of the wheel to determine the frequency of the instruction signals generated by the signal generation means.

2. The input device of claim 1, wherein the rotation resistant force is provided by the conductive element and the click portion.

3. The input device of claim 2, wherein the rotation resistant force includes the friction force occurred between the conductive element and the click portion and the elastic return force of the conductive element.

4. The input device of claim 1, wherein the wheel has a rotational inertia determined by the weight of the wheel and an axle of the wheel.

5. The input device of claim 4, wherein the inverse relationship is formed by the composite force against the rotational inertia.

6. The input device of claim 1, wherein the wheel is a circular disk.

7. The input device of claim 6, wherein the inverse relationship is formed by a net value derived by subtracting two times of a multiplication product of the rotation resistant force and the rotation moment of force from the multiplication product of the force to generate rotation and the rotation moment of force divided by the weight and the square of an axle of the wheel.

8. The input device of claim 1, wherein the conductive element includes a metal pin and an elastic element connecting to one end of the metal pin.

9. The input device of claim 8, wherein the elastic element has one end connecting to a first electrode, the two legs being connected to a second electrode and a third electrode.
